(19) United States
(12) Patent Application Publication
(10) Pub. No.: US 2011/0013413 A1
(43) Pub. Date: Jan. 20, 2011

(54) VEHICLE LAMP ASSEMBLY IMPROVEMENT

(76) Inventor: A-Sheng Yang, Taipei Hsien (TW)

Correspondence Address: A-Sheng Yang, 235 Chung - Ho, Box 8-24, Taipei, 235, TW

(21) Appl. No.: 12/503,079

(22) Filed: Jul. 15, 2009

(51) Int. Cl. B60Q 1/00; F21V 21/00; F21V 7/00

(52) U.S. Cl. 362/545; 362/549; 362/509

(57) ABSTRACT

An improved vehicle lamp assembly includes a lamp seat with a circuit board arranged on a top of the lamp seat. The circuit board has a plurality of retaining holes for receiving retaining sheets. The retaining sheets are inserted into the retaining holes as a pyramid. Light Emitting Diode (LED) is arranged onto a surface of each retaining sheet so that a wide illumination of lights by the LEDs is formed.

### FIELD OF THE INVENTION

The present invention relates to lamp assembly, and particular to an improved vehicle lamp assembly providing a wider illumination by fixed LED assembly.

### DESCRIPTION OF THE PRIOR ART

Referring to FIG. 1, a prior LED lighting assembly is illustrated. LEDs 23 are perpendicularly arranged to a lamp seat 10. Lights are concentrated straight forwards. When such assembly is applied to a stop light of a vehicle, other vehicles in laterally back of the assembly will not being obviously warned by the light.

Therefore, by continuous researches, experiments, and improvements, an improved vehicle lamp assembly capable of providing wider illumination by fixed LED assembly is developed by the inventor of the present invention. A sufficient warning effect for the stop light can be provided by the present invention.

### SUMMARY OF THE PRESENT INVENTION

Accordingly, the primary object of the present invention is to provide an improved vehicle lamp assembly capable of providing wider illumination.

To achieve above objects, the present invention provides: a lamp seat with a circuit board arranged to a top of the lamp seat; the circuit board having a plurality of retaining holes for receiving retaining sheets; the retaining sheets being inserted into the retaining holes as a pyramid; at least one Light Emitting Diode (LED) being arranged onto a surface of each retaining sheet.

Comparing with the prior art, the present invention mentioned above uses LED as a lighting source instead of a prior halogens lamp which is more power-saving, and with lower consumption. The retaining sheets are assembled as a pyramid. LED is arranged onto a surface of each inclined retaining sheet so that lights will be emitted widely around the pyramid assembled by the retaining sheets.

### BRIEF DESCRIPTION OF THE DRAWINGS

FIG. 1 is a schematic view showing an illumination of a prior LED lamp assembly.

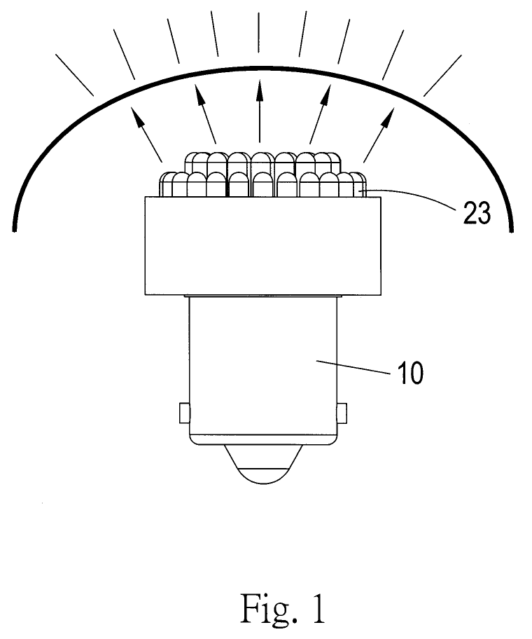

FIG. 2 is an exploded view of the present invention.

FIG. 3 is a pictorial drawing of the present invention.

FIG. 4 is a schematic view showing an operation of the present invention.

FIG. 5 is a schematic view showing another embodiment of the present invention.

FIG. 6 is a schematic view showing one another embodiment of the present invention.

FIG. 7 is a schematic view showing a yet embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

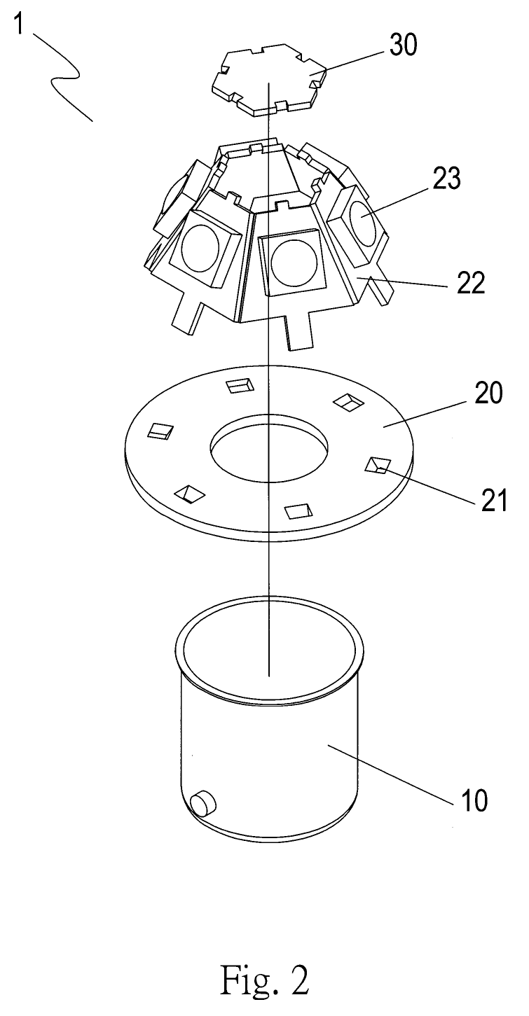

Referring to FIG. 2, an exploded view showing an improved vehicle lamp assembly according to the present invention is shown. The vehicle lamp assembly includes following components.

A lamp seat 10 with a circuit board 20 soldered on a top of the lamp seat 10.

The circuit board 20 has a plurality of retaining holes 21 for receiving retaining sheets 22. The retaining sheets 22 are assembled as a pyramid. Light Emitting Diode (LED) 23 is soldered onto a surface of each retaining sheet 22 so that lights will be emitted around the pyramid assembled by the retaining sheets 22. A reflecting mirror 30 is covered on a top of the pyramid so that lights will also be reflected from the reflecting mirror 30.

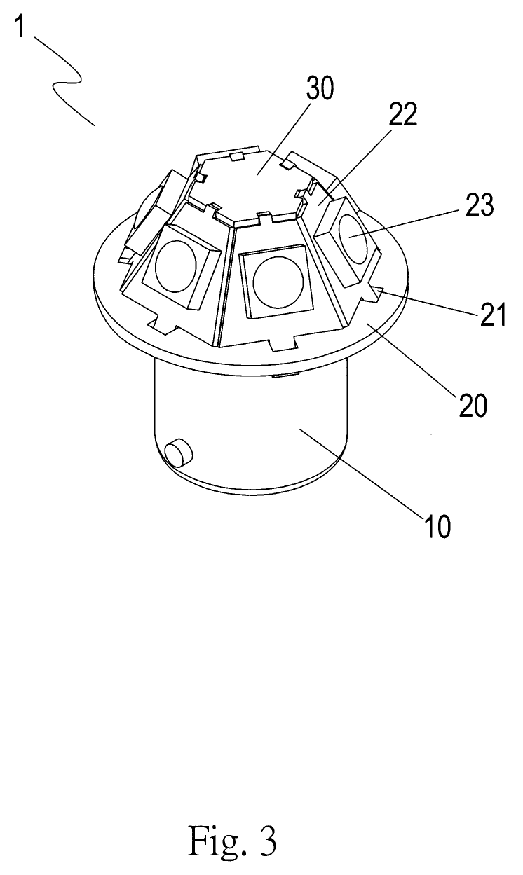

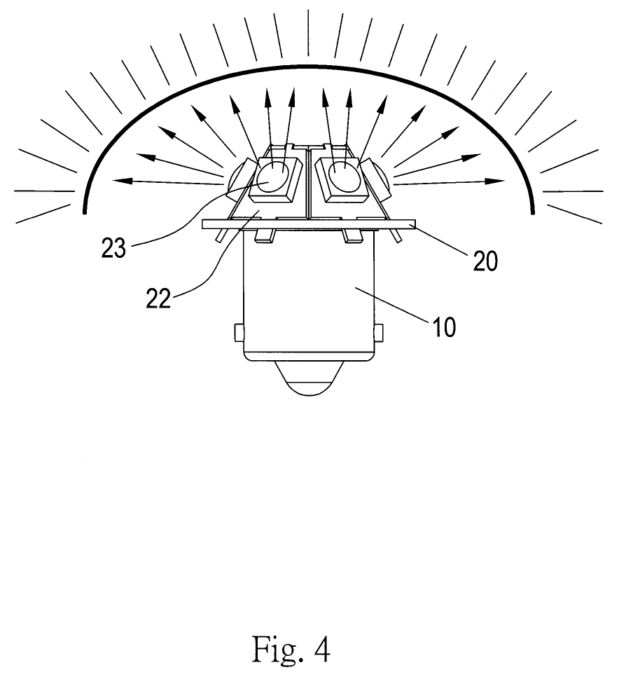

Referring to the FIG. 3, a schematic view showing an assembly of the present invention is illustrated. A schematic view showing an operation of the present invention is illustrated in FIG. 4. The retaining sheets 22 are assembled as a pyramid. LED 23 is soldered onto the surface of each inclined retaining sheet 22 so that lights will be emitted widely around the pyramid assembled by the retaining sheets 22.

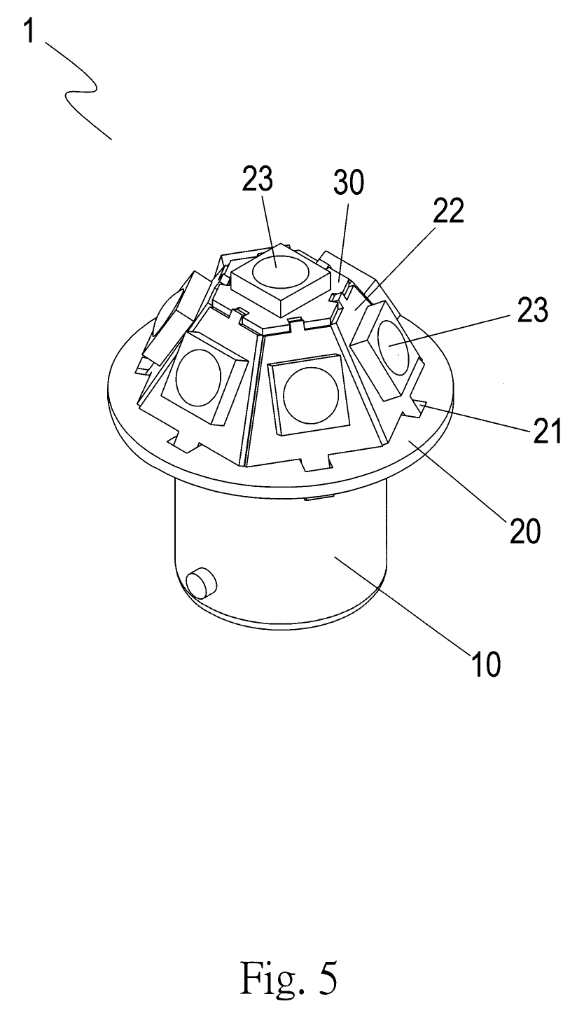

Moreover, another embodiment according to the present invention is illustrated in FIG. 5. The reflecting mirror 30 on the top of the pyramid assembled by the retaining sheets 22 is further arranged with a LED 23 so as to increase an intensity of illumination.

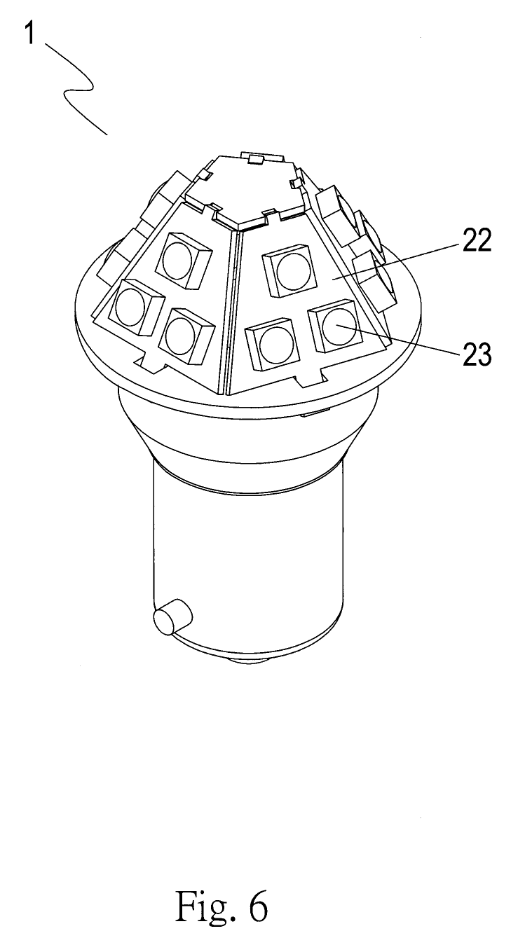

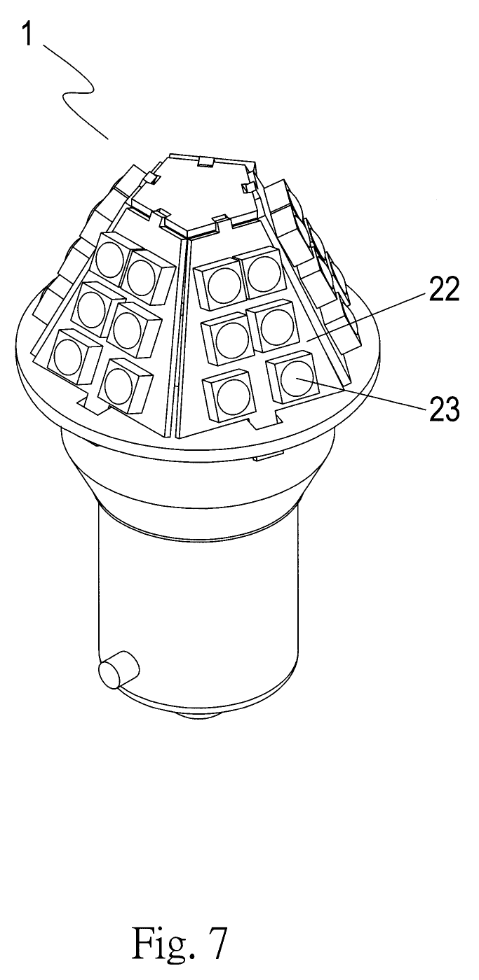

With reference to FIGS. 6 and 7, another two embodiments according to the present invention are schematically illustrated. A plurality of LEDs 23 are soldered onto each retaining sheet 22. The LEDs can be red, orange, yellow, green, blue, or purple LEDs.

The advantages of the present invention are in the following.

1. Simple structure of the present invention is practical and suitable for production.

2. Wide illumination of lights is formed by the surfaces of the inclined retaining sheets with a plurality of LEDs.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle lamp assembly comprising:
a lamp seat with a circuit board arranged to a top of the lamp seat;
the circuit board having a plurality of retaining holes for receiving retaining sheets; the retaining sheets being inserted into the retaining holes as a pyramid; at least one Light Emitting Diode (LED) being arranged onto a surface of each retaining sheet.

2. The vehicle lamp assembly as claimed in claim 1, wherein a reflecting mirror is covered upon the retaining sheets so that lights will be reflecting thereby.

3. The vehicle lamp assembly as claimed in claim 2, wherein at least one LED is arranged onto a surface of the reflecting mirror.

4. The vehicle lamp assembly as claimed in claim 1, wherein the LEDs are combination of a red, orange, yellow, green, blue, or purple LED.
